(19) United States
(12) Patent Application Publication
(10) Pub. No.: US 2015/0298253 A1
(43) Pub. Date: Oct. 22, 2015

(54) SYSTEMS AND METHODS FOR PATTERNING USING A LASER

(71) Applicant: RevoLaze, LLC, Westlake, OH (US)

(72) Inventors: Darryl J. COSTIN, JR., Avon, OH (US); Darryl J. COSTIN, SR., Westlake, OH (US)

(21) Appl. No.: 14/690,856

(22) Filed: Apr. 20, 2015

Related U.S. Application Data
(60) Provisional application No. 61/981,250, filed on Apr. 18, 2014.

(51) Int. Cl. B23K 26/00; D06M 10/00; B23K 26/073; B23K 26/06; B23K 26/02

(52) U.S. Cl. CPC B23K 26/0084; B23K 26/003; B23K 26/0643; B23K 26/02; B23K 26/073; D06M 10/005

(57) ABSTRACT

The present invention generally relates to a surface treatment of fabric with a laser and, more specifically, to a system and method for generating a pattern used to process a surface of a fabric through laser irradiation and the fabric resulting from such treatment. The present invention provides small laser spot sizes while operating a laser at large field size by 1) using a laser system with post-objective scanning architecture; 2) using multiple lasers across the width of a fabric roll; and/or 3) increasing the size and weight of the laser scanning mirrors. The spot size normally associated with a smaller laser field size (e.g. 500 mm) may be achieved with a laser having a larger field size (e.g. 950 mm or greater) by practicing the teachings of this invention.

### CROSS-REFERENCE TO RELATED APPLICATION

This application claims the benefit of priority to U.S. Provisional Application No. 61/981,250 filed on Apr. 18, 2014, the complete disclosure of which is incorporated herein by reference.

### FIELD OF THE INVENTION

The present invention generally relates to surface treatment of fabric with a laser, and, more specifically, to systems and methods for generating a pattern on a fabric surface through laser irradiation, and to treated fabrics resulting from such treatment, especially denim fabric.

### BACKGROUND

Fabrics, such as denim, can be processed to simulate a worn look. Conventionally, a wet process, such as a stone and/or enzyme process, is applied to the fabric, typically after the fabric has been transformed into a garment, to create a faded and worn look. Specifically, an enzyme wash in combination with an agitation element, such as stones or rocks, removes color from a ridged blue denim fabric to develop a contrasting pattern of variable color intensities creating a stonewashed look. The faded areas of the denim fabric correspond to where stones or rocks contact the fabric during the enzyme washing process.

Traditional stonewash and/or enzyme processes have numerous drawbacks. For example, each manufacturing cycle requires extensive time to create the stonewashed look, where a significant amount of water is used during the process. In addition, the handling and disposal of the enzymes and wastewater require substantial attention regarding environmental concerns.

Ring spun denim is a type of fabric that is processed into garments. Ring spun denim is a strong durable fabric that includes imperfections, known as slubs. Slubs may be present as thicker areas along a yarn. These imperfections create a unique vintage quality look. In addition, ring spun denim has a more luxurious texture because more cotton fibers are used to create the yarn for ring spun fabric than conventional denim fabric. Due to the characteristics of the yarn, ring spun fabric tends to fade more evenly, contributing to a more authentic vintage look. However, the fabric used in ring spun denim costs more than standard denim fabric due to the relative inefficiencies in manufacturing the ring spun product.

Lasers have been proposed to process graphics and patterns onto fabric surfaces, thereby creating different denim looks using a dry process. However, re-creating the look of a wet process such as an enzyme wash or stonewash using a laser processing technique is difficult due to the random and unique characteristics created during an enzyme wash and a stonewash. Specifically, previous laser methods implemented uniform, repeating patterns that have not adequately captured the contrast in color intensity to create an atheistically pleasing enzyme and stonewash pattern. Nor has there been a method of simulating the look and feel of ring-spun denim using lasing techniques.

Typically, denim is processed in a “large field size.” There are two major problems in creating a denim look with a laser for large field sizes, such as 50-80 inches. First, the graphic images that can duplicate the different desired new and existing denim looks are not readily available. The graphic images must be developed from software that allows for manipulation of the graphic, sometimes pixel by pixel, where different laser intensities can be assigned to specific areas of the graphic. Further, the graphic must be manipulated to provide different random and ordered effects. A simple graphic pattern repeated over the denim surface cannot simply replicate the unique look of enzyme and stonewashed or the ring spun denim. The uneven texture of enzyme washed and stonewashed products and the random (or sometimes ordered) and irregular fading characteristics complicate the ability of a single graphic pattern to accurately replicate that look. Second, even if graphics could be developed using software to replicate the different denim looks by laser scribing conventional denim, the graphics would require a fine resolution not available at large field sizes required to lase, for example, a 70 inch denim roll. Larger field sizes produce larger diameter laser spot sizes which result in poorer resolution than for smaller field sizes with smaller diameter laser spot sizes.

Therefore, there is a need for systems and methods for generating high resolution image on fabric surfaces at large field sizes through laser irradiation.

### SUMMARY OF THE INVENTION

An aspect of the present invention relates to systems and methods for generating a pattern on a surface of a work piece, such as a fabric, by laser irradiation. The systems and methods may provide an enzyme/stone washed pattern, a ring-spun pattern, and other patterns on conventional open ended denim by processing fabric rolls with a laser.

A typical fabric roll, such as a denim roll, is about 1800 mm or greater in width. To achieve the resolution required to generate a satisfactory image as contemplated by the inventors on the surface of the denim roll, the laser spot size should be about 0.55 mm or less. However, certain standard available laser system can only achieve that spot size at a 500 mm field size. The larger the field size, the larger the spot size. To use the same laser system to lase an 1800 mm field size, such as that of a denim roll, would produce a spot size much greater than 0.55 mm, which cannot generate sufficient fine resolution to create the desired fabric pattern. The present inventors have developed a method to decrease the laser spot size of existing lasers to operate at larger field sizes. The method includes: 1) using a laser system with post-objective scanning architecture; 2) using multiple lasers across the width of a fabric roll; and/or 3) increasing the size of the laser scanning mirrors.

Accordingly, a first aspect of the present invention provides a laser system configured for generating a pattern on a work piece, such as a fabric surface. The system contains a scanning architecture that is located after the objective lens (that is, a post-objective scanning architecture). “After,” as used herein, means that, when in use, the laser is directed through the objective lens, before arriving at the scanning mirrors. The post-objective scanning architecture may contain a first mirror configured to move the laser beam along an x-axis, and a second mirror configured to move the laser beam along a y-axis perpendicular to the x-axis. Further, the mirrors used preferably have a larger size than the mirrors used in a typical conventional laser system for the same field size. Preferably, the mirrors have a size of greater than about 50 mm, preferably about 50 mm to about 70 mm. As used herein, and as generally known in the art, the mirror size (in mm) is given in accordance to the diameter of the aperture through which the laser passes before arriving at the scanning architecture. As known in the art, the larger the aperture, the larger the beam leaving the laser, and thus, larger mirrors are required for the scanning architecture. Thus, the scanning mirrors in laser systems are ordinarily sized based on the diameter of the aperture. For example, a “33 mm mirror” is a mirror that is used for a laser that has a 33 mm aperture; a “50 mm mirror” is a mirror that is used for a laser that has a 50 mm aperture; etc. Because of the different possible shapes for the scanning mirrors, this convention allows for the mirror size to be standardized based on the aperture diameter. Notably, for the present invention, the mirror size may be increased without increasing the size of the objective lens or the aperture. The laser system may be configured to have a spot size of about 0.55 mm or less for a field size of about 900 mm or greater, preferably 950 mm or greater. Essentially, the system contains a) a post-objective scanning architecture with mirrors that are larger than those used in a comparative laser having a field size less than that of the laser apparatus and a spot size of about 0.55 mm; and b) an objective lens that is the same or similar size as that used in the comparative laser.

A second aspect of the present invention provides a method for modifying or retrofitting existing laser systems to achieve a smaller spot size for a larger field size. The method includes using post-objective scanning architecture having the first and second mirrors downstream of the objective lens, and mirrors larger than those conventionally used with the laser. The method preferably provides a laser system having a spot size of about 0.55 mm or less at a field size of about 900 mm or greater, preferably 950 mm or greater. More than one laser can also be combined to collectively cover a selected field size. For example, two lasers, each operating at field size of about 950 mm, can be combined to cover a field size of about 1800 mm.

A third aspect of the present invention provides a method for generating a pattern on a fabric surface. The method includes irradiating the width of the fabric roll with a laser spot of about 0.55 mm or less. The laser system used to generate the laser spot contains scanning mirrors that are located after the objective lens. Further, the mirrors used preferably have a larger size than the mirrors usually used in a typical laser system. Preferably, the mirror has a size of greater than about 50 mm, preferably about 50 mm to about 70 mm. The laser system is preferably configured to have a spot size of about 0.55 mm or less at a field size of about 900 mm or greater, preferably about 950 mm or greater.

Other aspects of the invention will become more apparent upon reading the following detailed description of the exemplary embodiments.

### BRIEF DESCRIPTION OF THE DRAWINGS

The accompanying drawings are incorporated in and constitute a part of the specification. The drawings, together with the general description given above and the detailed description of the exemplary embodiments and methods given below, serve to explain the principles of the invention. The objects and advantages of the invention will become apparent from a study of the following specification when viewed in light of the accompanying drawings, in which like elements are given the same or analogous reference numerals and wherein:

FIG. 1 shows a schematic view of an exemplary laser system having a post-objective scanning architecture; and

FIG. 2 illustrates a system for processing a fabric roll according to an exemplary embodiment.

### DETAILED DESCRIPTION OF EXEMPARY EMBODIMENTS

Reference will now be made in detail to exemplary embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in connection with the exemplary embodiments and methods.

Exemplary embodiments of the present invention provide systems and methods for decreasing the spot size of a laser while operating the laser at a larger field size. Certain exemplary embodiments utilize a laser combined with a number of optical elements to form a high resolution image on a large substrate, where the laser spot size is smaller than that normally associated with a given laser field size. The system and methods are capable of providing higher resolution images over larger field sizes than typical laser etching systems, and are useful for continuous laser printing of a pattern on a workpiece, such as a fabric roll.

Typically, fabric rolls come in sizes of about 70 inches (about 1800 mm) or greater in width. The inventors prefer to lase a pattern having the desired resolution using a laser spot size of about 0.55 mm or less. For certain laser systems, that spot size is available for a 500 mm or less field size. However, if the same system is used at a field size of the 1800 mm, the spot size would be much larger (e.g. about 2 mm), which cannot provide the desired fine resolution. A problem is that larger field sizes correspond to larger laser spot sizes, and thus, lower resolution of the resulting graphic. The inventors have provided a way to remedy this problem by modifying the laser system to produce the fine resolution achieved by a smaller field size laser at a larger field size. Specifically, one or more or all of the techniques can be employed: 1) using a laser system with post-objective scanning architecture; 2) using multiple lasers across the width of a fabric roll; and/or 3) increasing the size of the laser scanning mirrors. In an embodiment, all three techniques are utilized simultaneously.

In exemplary embodiments, the laser system of the present invention has a scanning architecture that is located after the objective lens. Some galvanometric laser systems are often equipped with pre-objective scanning mirror architecture where the mirrors are located before the objective or focus lens. The inventors have discovered that lasers equipped with post-objective scanning mirror architecture can produce finer laser beam spots for larger field sizes, and therefore finer resolution useful in creating detailed graphic images. Laser systems equipped with post-objective scanning mirror architecture have the mirrors located after the objective or focus lens.

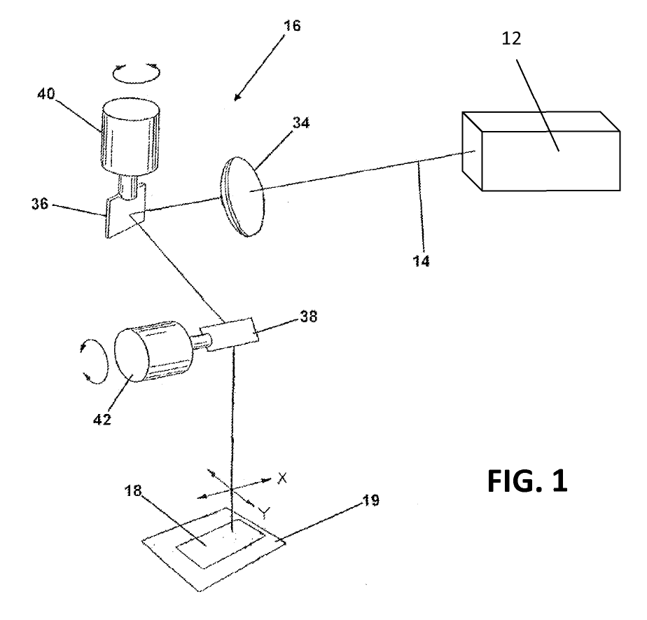

FIG. 1 illustrates an exemplary laser system 16 with a post-objective scanning architecture. Laser 12 generates a laser beam 14 which is directed through an objective lens 34 that focuses the beam 14 in the direction of a beam directing and scanning device having a first mirror 36 and a second mirror 38. The laser 12 may be any of a variety of types of lasers, for example a CO₂ laser or an yttrium aluminum garnet (YAG) laser. In an exemplary embodiment the laser 12 is capable of operating at a power range between 500-5,000 watts. The first mirror 36 is mounted on a first galvanometer 40 so that the first mirror 36 can be rotated to move the beam in an x-axis relative to a support stage 19. A second galvanometer 42 is used to control the second mirror 38 so that the mirror 38 can move the beam on the support stage 19 along a y-axis perpendicular to the x-axis. In other words, mirrors 36 and 38 can be controlled to scan the laser beam on the support stage 19 to generate any pattern on a fabric surface through laser irradiation. Although FIG. 1 shows the first mirror 36 being an x-axis mirror and the second mirror 38 being a y-axis mirror, they can be interchanged so that the first mirror 36 is a y-axis mirror and the second mirror 38 is the x-axis mirror. The laser beam 14 is deflected first by the first mirror 36 and subsequently by the second mirror 38 to direct the beam to the support stage 19 which supports a fabric 18 thereon. The support stage 19 has a working surface which can be almost any substrate including a table, or even a gaseous fluidized bed. The fabric 18 (to be processed through laser irradiation) is placed on the working surface. Usually, the laser beam is directed generally perpendicular to the surface of the support stage 19, but it may be desirable to guide the beam to the surface with an angle to achieve certain effects. For example, the incident angle may range between about 45° and about 135°.

The objective lens 34 reduces the spot size of the laser prior to directing the laser to the scanning mirrors 36, 38. The objective lens 34 is preferably a multi-element, flat-field, focusing lens assembly, which is capable of optically maintaining the focused spot on to the first mirror 36. While a single objective lens 34 is shown and described in FIG. 1, multiple lenses may be used in the laser system 16. The objective lens 34 may also be used in conjunction with an expander lens as disclosed in U.S. Patent Application Publication No. 2011/0187025. The focusing lens 34 may have at least one dimension of 0.5 inches or greater, possibly between 0.5 inches and 6.5 inches. The dimension will be dependent on the shape of the objective lens(es) used so that the dimension may be a diameter for a circular lens, a length or height for polygon lens, the length of a major or minor axis for an elliptical lens, etc. The dimensions and shape of the various objective lens(es) may be the same or they may vary,depending on the initial parameters of the laser and the final desired output.

The laser system 16 may also include or associate with other components such as pattern generating devices, control devices, communication links, computers, etc. as defined in co-pending U.S. Patent Application Publication No. 2015/0079359, which is incorporated herein by reference.

In certain embodiments, multiple lasers can be used to print a pattern on the fabric surface. In order to process larger work pieces, such as a 70-inch fabric roll in either a linear or indexed process, the laser field size would need to be at least the width of the roll (1800 mm). The typical spot size for a laser system (e.g. Lasx Industries, Inc. LPM 2500 which is a 2,500 watt CO₂ laser, with a field size of 1800 mm) is about 2.0 mm. However, a 2.0 mm spot size is too large to provide sufficient resolution to produce desired patterns on a fabric surface, such as ring spun and various slub denim patterns or to replicate the stone/enzyme wash look or to realize fine texture patterns. The inventors have determined that to produce stone/enzyme wash and ring spun patterns on fabric surfaces, the laser spot size should be about 0.55 min or less. Larger spot sizes result in coarser graphic patterns which do not accurately replicate the desired fine pattern on the fabric surface.

In order maintain a spot size of about 0.55 mm or less in a large field size, more than one laser can be used to collectively cover the width of the fabric surface (e.g., a field size of 1800 mm). For example, two lasers can be used to lase an 1800 mm or greater fabric roll width with each laser processing up to 900 mm width, preferably about 950 mm with. Because the laser spot diameter for a 950 mm field size laser is substantially smaller than that for an 1800 mm laser field size, as shown in Table 1 below, using two lasers, with the first laser dedicated to one side of the field and the second laser dedicated to the other side of the field, allows a smaller spot size, i.e. 0.83 mm to generate a pattern on the fabric surface. However, this is still short of the goal of achieving a spot size less than 0.55 mm. More than two lasers can be used as long as the field sizes of the lasers add up to approximately the field size required for the fabric surface. For example, three lasers operating at a field size of 500 mm each may be used to lase patterns on a roll of fabric having a width of about 1400 mm. This allows for further reduction of spot size. Other combinations are also appropriate as long as the sum of the field sizes of the lasers add up to approximately the width of fabric.

TABLE 1
Impact of Field Size on Spot Size for a Laser

| Field Size (mm) | Spot Size (mm) |
|---|---|
| 500 | 0.55 |
| 950 | 0.83 |
| 1800 | 2.00 |

One problem that may arise from using more than one laser to collectively lase a width of the fabric is that the resulting pattern may include gaps at the joints where the two or more laser scans meet. For example, if a denim roll is 60 inches wide, one laser can etch the first 30 inches and another laser can etch the second 30 inches. To run in a linear process, a graphic may be broken up into individual parts and each laser etches one part until the entire graphic is finished. If the denim is lased vertically along the width, each line from each laser will meet in the middle of the denim roll. When this occurs, there is typically a gap of unlazed fabric where the two lasers meet. That problem can be eliminated by staggering the laser lines from part to part and in the joints where the laser scans meet. Here, the laser fields are allowed to overlap to print overlapping patterns. According to an exemplary embodiment, to service a total field size of 1800 mm, two lasers, each having a 950 mm field, are used to allow for a 50 mm overlap from each laser. As such, the field of each laser should be calculated so that it is greater than the total field size to allow for overlap of the pattern of each laser. Preferably, the overlap should be about 1% to about 50% of the total desired field size, more preferably about 2% to about 10%.

In a further embodiment, the first and second mirrors 36, 38 can be replaced with larger mirrors to reduce the laser spot size. The mirrors 36, 38 may be flat mirrors and can have a variety of shapes, including polygonal and circular. The inventors have surprisingly discovered that, for a given objective lens size and other optics in the laser system, laser spot size can be reduced by increasing the size of the mirrors (without a corresponding increase in the size of objective lens 34). The functionality of the mirrors is to direct the laser beam to the work piece and scan the laser beam across the work piece along a predetermined path. The mirror size is normally not expected to affect the spot size. However, the inventors have unexpectedly discovered that for a given objective lens and optics system, increasing the mirror size can, in and by itself, reduce the laser spot size. The present inventors have unexpectedly discovered that increasing the mirror size alone (without increasing the corresponding objective lens 34) can decrease the laser spot size.

Table 2 shows the effect of mirror size on laser spot size while otherwise keeping the laser system unchanged. Table 2 shows that the use of larger scanning mirrors (without decreasing the size of the objective lens 34 size or the aperture size) for a given field size can significantly reduce the spot size for a given objective lens and optics system. Preferably, the mirror has a size of about 50 mm or greater for a laser operating at a field size of 900 mm or greater, preferably about 950 or greater. Preferably, the mirrors are sized so that a spot size of about 0.55 mm or less is achieved for a given field size. Exemplary embodiments contemplate using mirrors that are 25% to 500% larger than those associated with a laser having a 500 mm field size and 0.55 mm spot size (typically about 33 mm), preferably about 50% to about 200%. By using the larger mirrors while keeping the lens size the same or similar, spot sizes of about 0.55 mm can be achieved with a laser field size of about 900 mm, preferably about 950 mm. Hence the fine resolution graphics such as ring spun and stone/enzyme wash replications can be produced across full width textile rolls of about 70 inches.

TABLE 2
Impact of Mirror Size on Spot Size

| Mirror Size (mm) | Field Size (mm) | Spot Size (mm) |
|---|---|---|
| 33 | 500 | 0.55 |
| 33 | 950 | 0.83 |
| 50 | 950 | 0.5 |
| 70 | 950 | 0.43 |

In using larger mirrors, however, problems may arise with the ability to obtain a good quality laser etched image in specific areas where the mirrors would have to start up, change direction, or stop to etch a graphic. Those problems may be reduced or eliminated by reducing the maximum scan speed of the laser. Use of the largest mirrors shown in Table 2 (70 mm) significantly reduces the maximum scan speed (and thus the throughput), as shown in Table 3 below. The use of the 70 mm mirrors can only achieve maximum scan speeds of about 26 meters per second. However, with the use of 50 mm mirrors both small spot size and acceptable scan speed can be realized. The inventors have observed that, even with laser power approaching 2,500 watts, the laser scan speed is often less than 50 meters per second to produce the energy density necessary to generate proper intensity of the graphic elements. So, this reduction in laser scan speed may not be a major disadvantage.

TABLE 3
Impact of Mirror Size on Spot Size

| | | | Max. Scan Speed |
|---|---|---|---|
| Mirror Size (mm) | Field Size (mm) | Spot Size (mm) | (m/sec) |
| 33 | 500 | 0.55 | 34 |
| 33 | 950 | 0.83 | 62 |
| 50 | 950 | 0.5 | 52 |
| 70 | 950 | 0.43 | 26 |

If faster scan speed is desired, it may be desirable to use two lasers, each having a moderate mirror size (e.g. 50 mm instead of 70 mm), which provides a compromise between increasing scan speed and reducing spot size. An exemplary embodiment allows for faster scan speeds (e.g. 52 msec instead of 25 m/s) to provide a substantial increase in throughput. This embodiment may even allow for higher power lasers, such as 5,000 watt lasers, to provide the energy density required to process various graphic patterns on 72 inch denim rolls. If the required energy density for a given graphic pattern can be achieved with 2500 watt laser (e.g. operating at 52 m/s scan speed), then extremely high throughput can be achieved.

The embodiments of the present invention may be used alone or combined to achieve a spot size of 0.55 mm or less at a field size of about 900 mm or more, preferably about 950 mm or more. In a preferred embodiment, a post-objective architecture can be used together with larger mirrors to achieve a spot size of 0.55 mm or less at a field size of 950 mm or more. In another preferred embodiment, a post-objective architecture can be used together with multiple cameras to achieve a spot size of 0.55 mm or less at a total field size of about 900 mm or more, preferably about 950 mm or more, with a scan speed of 52 m/s or less, preferably about 25 m/s to about 52 m/s. In a further preferred embodiment, a post-objective architecture may be used together with larger mirrors and multiple lasers to achieve a spot size of 0.55 mm or less at a total field size of about 900 mm or more, preferably about 950 mm or more, with a scan speed of about 52 m/s or less, preferably about 25 m/s to about 52 m/s.

The spot size normally associated with a smaller laser field size (e.g., 500 mm) may be achieved with a laser having a larger field size (e.g., 950 mm or greater)) by practicing the teachings of this invention. For example, the spot size at the work piece for a laser having a 500 mm field is about 0.55 mm. The spot size at the work piece for the same laser at 950 mm field may be about 0.83 mm, and the spot size at the work piece for the same laser at 1800 ram field may be about 2,00 mm. Therefore, by practicing the teachings of this invention, laser spot sizes at the workpiece of 0.55 mm or less may be uniquely achieved for 950 mm and even 1800 mm laser field sizes if multiple lasers are used in the system.

Although preferably used to lase patterns on a fabric surface, the laser system described above can be used to pe a wide variety of operations on a number of different materials. For example any material which can be laser etched will benefit from the present invention which provides a higher resolution and finer detail at a faster throughput over a larger field size than traditional laser systems. Laser etching may be performed on large glass pieces or other building products used in residential and commercial buildings. Large work pieces may be etched to provide high resolution patterns and graphics of different designs. Laser etching fine resolution images or perforations on leather or cloth parts, such as automobile interiors, can also be improved. For instance, instead of laser etching one leather seat part at a time, several seat parts can be laser etched at once.

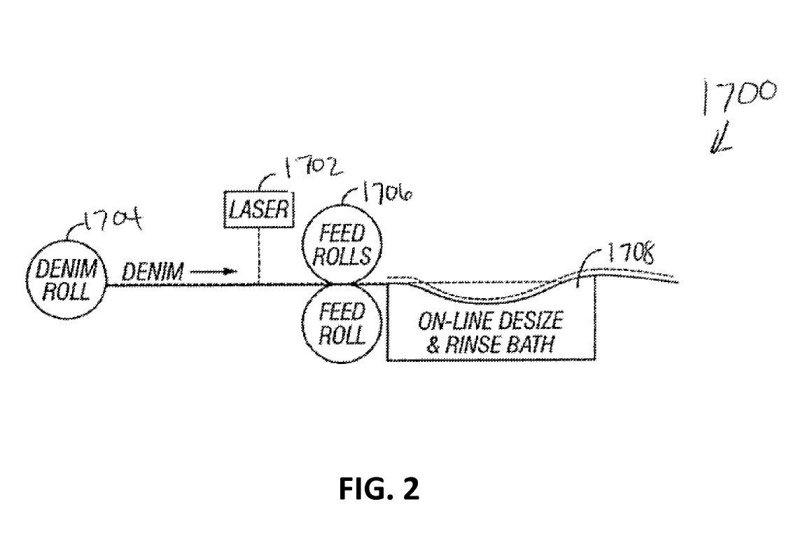

The above-described methods and systems can be used in various laser processing systems. For example, as illustrated in FIG. 2, system 1700 includes a laser 1702 used to process a surface of the fabric based on the generated pattern is mounted over a table and one or more lasers can scribe the patterns onto the fabric. When a plurality of lasers is implemented, the lasers can collectively translate across the width of the fabric roll and/or along the machine direction (e.g., in the direction of the length of the denim). Specifically, the fabric can be fed onto the table from a denim roll 1704 using feed rolls 1706. In one embodiment, no further processing is necessary.

In another exemplary embodiment, the fabric can be further processed or washed using a rinse. For example, the fabric can be exposed to a conventional residential laundering process using a washing machine and detergent. Alternatively, the processed fabric can be further processed using a desizing agent or enzyme rinse. Specifically, the fabric can be washed in the on-line desize and rinse bath 1708. In an alternative embodiment, the fabric can be separately washed after assembly of the garment made using the fabric where the garment can include jeans, jackets, caps, etc. Implementation of exemplary embodiments of the invention has the desired effect of minimizing if not eliminating a need to launder or otherwise wet process the lazed fabric.

In an exemplary embodiment, the method of processing a surface of a fabric through laser irradiation can use a fabric where the fabric is made of a woven material (such as denim). The woven material can include a plurality of yarns. Because the laser impinges upon an exposed surface of the woven material, the dye on the yarns associated with that surface are modified. Other surfaces of the woven fabric, and other threads not exposed to laser irradiation retain the original color of the fabric. In other words, in dry processing techniques, after the fabric is processed to include an image associated with a pattern generated as described above, only the surface in which the laser impinges is processed. The surface of the fabric that is not exposed to laser irradiation remains unchanged and no processing is present within that surface. In contrast, wet processing techniques treat both sides of the fabric such that a change in mechanical and/or chemical properties is introduced to each side of the fabric.

The foregoing detailed description of the certain exemplary embodiments has been provided for the purpose of explaining the principles of the invention and its practical application, thereby enabling others skilled in the art to understand the invention for various embodiments and with various modifications as are suited to the particular use contemplated. This description is not necessarily intended to be exhaustive or to limit the invention to the precise embodiments disclosed. The specification describes specific examples to accomplish a more general goal that may be accomplished in another way.

What is claimed is:

1. A system for generating a pattern on a work piece comprising a laser apparatus having a. a post-objective scanning architecture, wherein mirrors in the post-objective scanning architecture are larger than those used in a comparative laser apparatus having a field size less than that of the laser apparatus and a spot size of about 0.55 mm; and
b. an objective lens that is the same size as that used in the comparative laser apparatus.

2. The system of claim 1, wherein the work piece is a fabric surface.

3. The system of claim 2, wherein the fabric is denim.

4. The system of claim 1, wherein each of the mirrors has a size of about 50 mm or greater and the laser apparatus has a field of about 950 mm or greater.

5. The system of claim 1, wherein the system produces a spot size of about 0.55 mm or less at a field of 950 or greater.

6. The system of claim 1, wherein the field size of the laser apparatus is at least about 90% greater than that of the comparative laser.

7. The system of claim 1, wherein the laser apparatus contains two or more lasers, each of the lasers contains its own post objective scanning architecture.

8. The system of claim 7, wherein the lasers have a combined field size that is larger than a desired field for the laser apparatus.

9. The system of claim 7, wherein the field for each of the lasers is at least about 950 mm and the desired field for the system is about 1800 mm.

10. A method for generating a pattern on a work piece comprising the steps of
a. providing the system of claim 1; and
b. irradiating the work piece with the laser apparatus.

11. The method of claim 10, wherein the work piece is a fabric.

12. The method of claim 11, further comprising the step of washing the fabric.

13. The method of claim 10, wherein each of the mirrors has a size of about 50 mm or greater and the laser apparatus has a field of about 950 mm or greater.

14. The method of claim 10, wherein the system produces a spot size of about 0.55 mm or less at a field of 950 or greater.

15. The method of claim 10, wherein the field size of the laser apparatus is at least about 90% greater than that of the comparative laser.

16. The method of claim 10, wherein the laser apparatus contains two or more lasers, each of the lasers contains its own post objective scanning architecture.

17. The method of claim 16, wherein the lasers have a combined field size that is larger than a desired field for the laser apparatus.

18. The method of claim 16, wherein the field for each of the laser is about 950 mm and the desired field for the system is about 1800 mm, and step b) occurs at a scan speed of about 52 m/s or less.

19. The method of claim 16, wherein the two lasers provides a region of overlapping patterns on the work piece.

20. A method for reducing spot size of an existing laser system, the method comprising the step of
a. providing a scanning architecture after an objective lens; and/or
b. replacing mirrors of the laser system with larger mirrors while keep the same objective lens.
